(19) United States
(12) Patent Application Publication
(10) Pub. No.: US 2008/0078497 A1
(43) Pub. Date: Apr. 3, 2008

(54) Method and Means of Applying Adhesive Tape

(75) Inventor: John Darcy Bradley, Feilding (NZ)

Correspondence Address: YOUNG & THOMPSON, 745 SOUTH 23RD STREET, 2ND FLOOR, ARLINGTON, VA, 22202, US

(73) Assignee: LEYHATTON INNOVATIONS LIMITED, WELLINGTON (NZ)

(21) Appl. No.: 11/659,835

(22) PCT Filed: Aug. 12, 2005
(86) PCT No.: PCT/NZ05/00204

§ 371 Date: Feb. 9, 2007

(30) Foreign Application Priority Data
Aug. 13, 2004 (NZ) 534671

(51) Int. Cl. B32B 37/12

(52) U.S. Cl. 156/270; 156/324; 156/355; 156/510; 156/538; 156/540; 156/580

(57) ABSTRACT

Apparatus for applying adhesive tape to an article having first and second surfaces to be securely joined together by the adhesive tape. The apparatus includes a gripper (11) which draws tape T from a reel R. A cutter assembly (14) is operable to cut the tape T to a required length. The length of tape is held by suction on grids (16). The grids (16) are moveable to a lowered position to enable the length of tape T to be transferred to application arms (21) and thereby be positioned adjacent the first and second surfaces. Applicating heads (30) are operable to press an area of the tape onto the first and second surfaces. Relative movement between the applicating heads (30) and the surfaces cause the tape to become adhered to and join the first and second surfaces.

### BACKGROUND TO THE INVENTION

This invention relates to a method and means of applying adhesive tape.

The present invention has particular application for applying adhesive tape to elements of a carton, container, case or like packaging and more particularly elements which overlap or are non-aligned such as overlapping closure flaps or a closure flap overlapping part of the body (base) of the carton.

In the following, the term “carton” will be used in a general sense to describe a container, which has a body (case) and a closure (e.g. lid, flap or the like). The carton can be made of cardboard or a plastic based material, such as polystyrene, or other suitable material which can be closed/sealed using an adhesive tape.

In such situations, the tape when applied tends to stretch directly across from one surface to the other. It, therefore, does not follow the contour of the edges of the abutting/overlapping elements. Also, there is a tendency for the tape to be in lateral tension and, therefore, tend to lift or pull away from one surface (generally the overlap surface). As a result of the foregoing, the tape does not add significantly to the strength or integrity of the carton.

New Zealand currently packs a significant proportion (approximately 90%) of its meat and related products in 20 kg cartons. These cartons are used to export a range of primary products including meat, offal and fish. Similar cartons are also in use in other countries. As a result, there is a growing need to provide a solution to the increasing challenges of ensuring packaging integrity, tamper evidence and product traceability.

For example, one current method of “sealing” cartons is to use strapping but strapping can easily be tampered without detection. Also, the polypropylene strapping used has become environmentally unacceptable.

While the present invention has particular application to applying adhesive tape to cartons used in the meat packaging field the invention is by no means limited to such applications. The inference to taping of such cartons is given solely by way of example.

### SUMMARY OF THE INVENTION

An object of the present invention is thus to provide a method of closing and/or sealing cartons by fixing one element of the carton e.g. a flap, closure element or other part to a second element of the carton e.g. base or another part of the carton by applying a pressure sensitive tape closure horizontally to encapsulate part of both elements around the or part of the perimeter of the carton so that the two elements can act as one with considerable strength.

It is another object of the present invention to provide a machine which is usable to close cartons by fixing one element/part of the carton to another element/part of the carton by applying a pressure sensitive tape closure horizontally to encapsulate parts of both the elements/parts around at least part of the perimeter of the carton so that the elements/parts can act as one with considerable strength.

In achieving the objects of the invention it is believed that generally a single length of tape around the carton will achieve what has previously required 2 or 3 pieces of tape, bands or other elongate joining elements.

Broadly according to one aspect of the invention there is provided an apparatus for applying adhesive tape to an article having first and second surfaces to be securely joined together by the adhesive tape the apparatus including tape dispensing means, tape holding means for holding a length of tape from the tape dispensing means and position the tape adjacent the first and second surfaces, pressure means operable to press an area of the tape onto said first and second surfaces and moving means to cause relative movement between the pressure means and first and second surfaces to cause the tape to become adhered to and join the first and second surfaces.

Preferably the tape holding means is moveable relative to a second tape holding means, there being transfer means whereby the length of tape can be transferred to the second tape holding means.

Preferably the second tape holding mean is moveable by moving means to position the tape relative to the first and second surfaces.

In the preferred form of the apparatus the pressure means includes at least one applicator head which is contactable with the non-adhesive side of the tape, there being means to cause relative movement between the first and second surfaces and the applicator head to cause said area of the tape to contact the first and second surfaces.

Preferably the applicator head includes a pair of rotatable elements mounted for relative movement therebetween whereby one rotatable element can be offset to the other rotatable element.

Preferably each rotatable element is of conical (more preferably truncated conical) shape, the conical surface forming a contact surface for pressing the tape onto the first or second surface. Preferably the apex of the conical shape or the end, which is of smaller diameter, is located more distant from the join of the first and second surfaces than the end of the largest diameter.

In a preferred form of the apparatus at least one of the conical rotatable elements includes a second contact surface, which inclines away from the largest diameter of the conical shape.

According to one form of the apparatus the applicator head(s) is/are moveable relative to the first and second surfaces.

According to a further form of the apparatus the first and second surfaces are also moveable in relation to the changing position of the applicator head(s).

In yet a further form of the invention the applicator head(s) is/are held in a substantially fixed position and the first and second surfaces are moveable by moving means.

Preferably the apparatus includes control means, which responsive to sensor means determining a type of article incorporating the first and second surfaces controls the dispensing means to cut the tape to a required length.

In the preferred form of the invention the dispensing means includes a reel of tape, a movable gripper to draw tape from the reel and cutting means to cut the tape at the required length.

In a preferred form of the invention the apparatus is arranged to perform horizontal application of tape to a carton. Preferably the tape holding means holds tape relative to the carton across a front face of the carton and moving means applies relative movement between the carton and tape holding means whereby the tape once applied across the front fence is pressed by the pressure means along the sides of the carton.

According to a further broad aspect of the invention there is provided an applicator head for application of adhesive tape to first and second surfaces to join the surfaces together, the applicator head being contactable with the non-adhesive side of the tape via elements in the form of a pair of rotatable elements mounted for relative movement therebetween whereby one rotatable element can be offset to the other rotatable element.

Preferably each rotatable element is of conical (more preferably truncated conical) shape, the conical surface forming a contact surface for pressing the tape onto the first or second surface. Preferably the apex of the conical shape or the end, which is of smaller diameter, is located more distant from the join of the first and second surfaces than the end of the largest diameter.

In a preferred form of the apparatus at least one of the conical rotatable elements includes a second contact surface, which inclines away from the largest diameter of the conical shape.

According to the second broad aspect of the invention there is provided a method of applying a length of adhesive tape to secure a first component having a face surface and an edge surface to a face surface of a second component, the method comprising steps of holding the length of tape in a position relative to face and edge surfaces, bringing pressure applying means into contact with an area of the tape to cause the tape in the vicinity of the contact area to contact said surfaces and then cause relative movement between said surfaces and the pressure applying means to occur to thereby cause the length of tape to become adhered along its length to the surfaces and follow the contour of the surfaces.

The method includes the step of drawing tape from storage means onto a tape holding means and cutting the tape to length.

In a preferred form of the method the holding means is moveable to move the length of tape to said position relative to the face and edge surfaces.

According to one form of the method the holding means is moveable to move the length of tape to said position relative to the face and edge surfaces.

According to one form of the method the length of tape is transferred from said holding means to second tape holding means prior to the pressure applying means causing the area of tape to contact the surfaces.

In one form of the invention the tape holding means is a reel.

Preferably in one form of the method pressure applying means is moved and the surfaces remain stationary.

According to another form of the invention the surfaces are moved and the pressure applying means remains stationary.

In yet a further form of the invention both the pressure applying means and the surfaces are moved.

In the preferred form of the method the first component is a closure of a carton and the second component is a case of the carton, the tape being applied horizontally around the carton. Preferably the tape is applied for the full peripheral extent of the carton.

Also in the preferred form of the invention the pressure applying means has first and second moveable pressure means one being cause to press part of the tape onto the face surface of the closure and the other being caused to press part of the tape onto the edge surface of the closure and the face surface of the case.

### BRIEF DESCRIPTION OF THE DRAWINGS

In the following more detailed description of the invention reference will be made to the accompanying drawings in which:

FIG. 1 provides a partial perspective view (and enlarged detail) of one type of carton to which an adhesive tape has been applied horizontally around the carton with the adhesive tape following the contour of the “gutter” formed by the edge of the lid adjacent a wall surface of the case,

FIG. 2 is a perspective view of an assembly which will form part of a machine, the assembly facilitating the cutting to length of adhesive tape and then supporting the adhesive tape ready for application of the length of tape to a carton,

FIG. 3 is a view similar to FIG. 2 but showing adhesive tape in the process of being dispensed from a roll of tape such that the dispensed tape can be cut to length and supported by a tape holding grid,

FIG. 4 is a view similar to FIG. 3 showing the tape fed from the reel and cut to length and supported by the tape holding grid,

FIG. 5 is yet a further similar view but showing the tape holding grid having moved to a position relative to tape application arms,

FIG. 6 is a view similar to FIG. 5 showing the tape transferred to the tape application arms and the tape holding grid in the process of reverting to its elevated position,

FIG. 7 is a view similar to FIG. 6 but with the tape applicating arms and the tape holding grid restored to the elevated position with a new length of tape in the process of being fed from the reel,

FIG. 8 is a view similar to FIG. 7 but showing the cut length of tape at the beginning of its application to a carton (not shown) and the new length of tape being further drawn from the reel,

FIG. 9 is a perspective view of a second example of how a carton can be presented to tape application arms,

FIG. 10 is a view similar to FIG. 9 but from a reversed position,

FIG. 11 is a perspective view of an example of a tape applicating head suitable for the machine for applying the tape to a carton the applicating head being of a type useable with, for example, the embodiment of the assembly shown in FIGS. 9 and 10,

FIG. 12 is a perspective view of the applicating head from a reverse angle,

FIG. 13 is a side elevation view of the tape applicating head,

FIG. 14 is a further perspective view of the tape applicating head,

FIG. 15 is a top plan view of the tape applicating head,

FIG. 16 is a side elevation view of the applicating head and a carton of the type shown in FIG. 1,

FIG. 17 is a perspective view of a form of tape cutter and gripping assembly,

FIG. 18 is a similar view to FIG. 16 showing the end of the tape being gripped prior to drawing of the tape from the reel, and

FIG. 19 is a view similar to FIG. 17 but with the tape in the process of being drawn from the reel.

### DESCRIPTION OF A PREFERRED EMBODIMENT OF THE INVENTION

It is intended that the machine according to the present invention will be able to handle different carton types including cartons typically used in the New Zealand meat processing industry. Thus it will be able to handle cartons including a three flap frozen carton with 1.5 mm gutter, a three flap frozen carton with full depth end flaps, a four flap frozen carton with lid in place and a four flap chilled type with 9 mm gutter. It will be appreciated by those skilled in the art that this is only by way of example intended to identify the versatility of a machine according to the present invention.

The term carton used herein is thus, as previously indicated, used in a general sense.

Each carton will preferably be supplied from the manufacturer with carton type identifier bar code. Thus the machine will include bar code reading means so as to be able to identify the type and specification of carton to which the adhesive tape is to be applied. Therefore, the PLC control system of the machine will, from the bar code read, be able to determine from stored information carton closure information including carton dimensions and centre line height. This will do away with the need for the machine to have sensing means to sense carton type, size etc.

In the event that no bar code is presented or a bar code is present for which no carton settings are known by the machine, the control system of the machine will control the machine such that the carton is passed straight through the machine i.e. without application of tape.

In the preferred form of the invention cartons to be closed are presented broadside, flap forward in the direction of travel as will hereinafter be evident.

Once again, this is by way of example as a means of describing a preferred form of the invention. It will be appreciated by those skilled in the art that other arrangements are possible. For example, the machine could be arranged to include provision for carton rotation so that an incorrectly presented carton could be automatically identified and then rotated to the correct orientation.

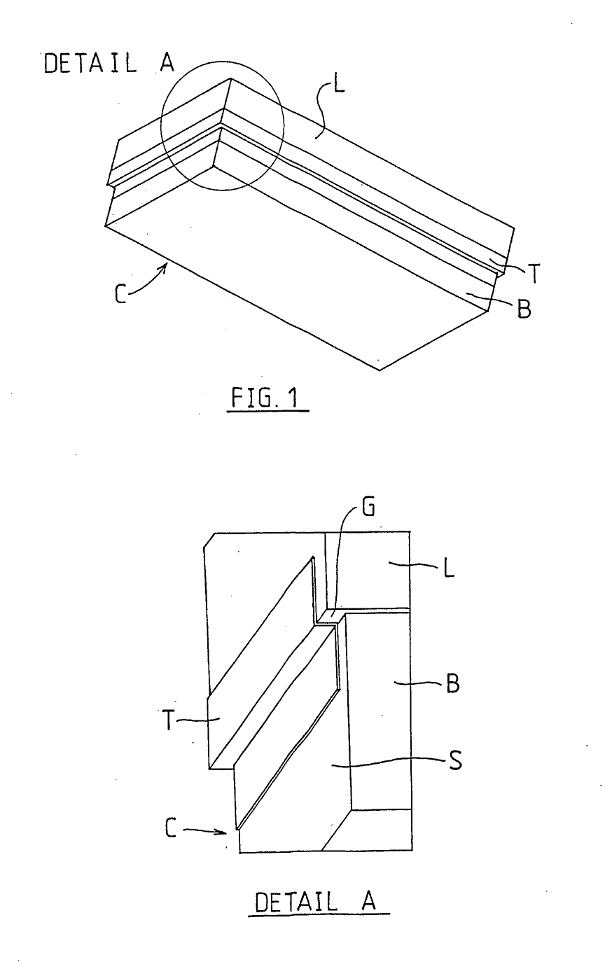

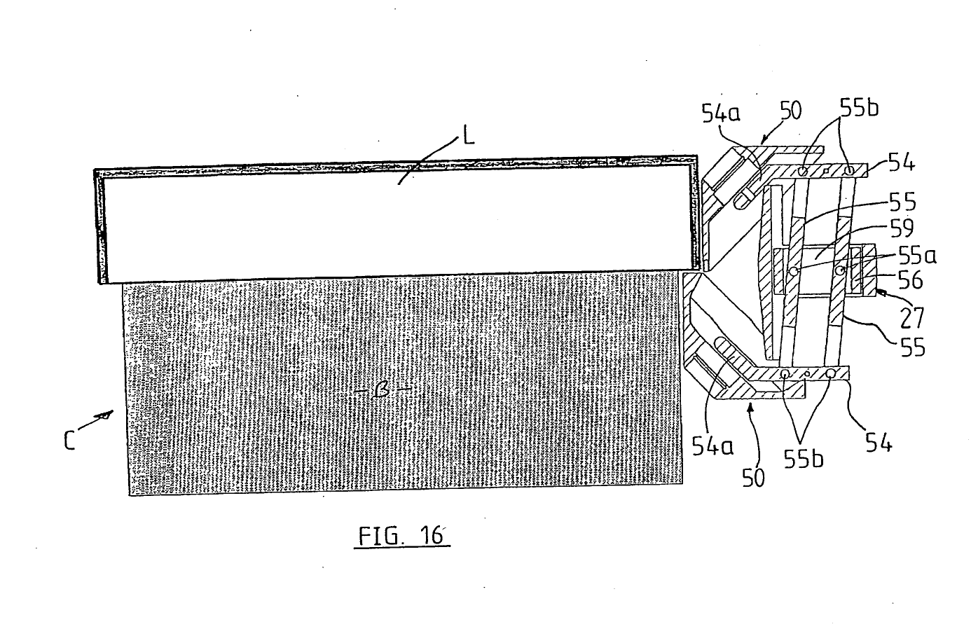

FIGS. 1 and 16 of the drawings illustrates a carton C having a base B and a lid L or lid flap. As can be seen the lid or lid flap overlaps with the sidewall S of the carton so as to form a gutter G which, effectively, is the edge of the lid or flap where it overlaps with the sidewall of the carton. The adhesive tape T is therefore, according to the invention, applied by the machine so that the tape follows the contours of the flap/lid L, the gutter G and the sidewall S of the carton C.

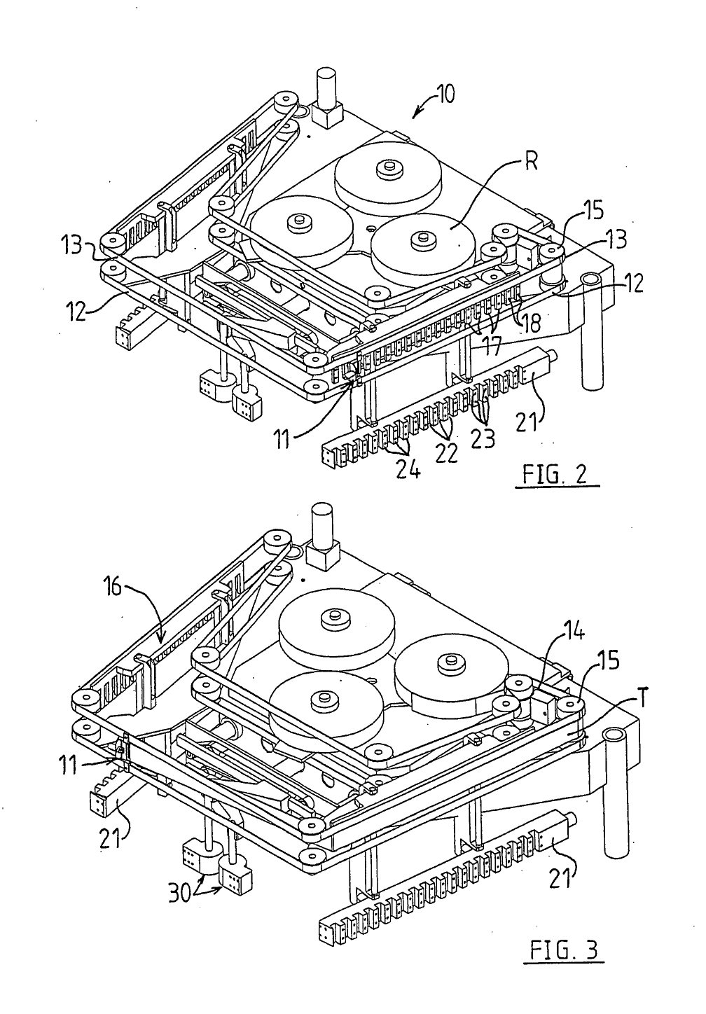

FIGS. 2-8 illustrate a frame assembly which facilitates the drawing of tape T from a reel R onto a tape holding grid and then transferring the tape (after it has been cut to length), to tape application arms to thereby support the tape for application to the carton by applicating heads.

As shown in FIG. 2, one or more reels R of tape T are supported by the assembly 10. In the illustrated arrangement three reels R are placed on friction mandrels in a carousel configuration.

The fag end of the tape T is attached to a gripper 11 which is mounted to and suspended between a pair of endless toothed belts 12 and 13. At initialisation the gripper 11 will be located adjacent a cutter mechanism 14 (see FIG. 19). Thus as shown in FIG. 3 movement of the belts 12 and 13 is initiated by a suitable powered source (motor) driving one or more drive rollers 15 which results in movement of the gripper 11 such that the tape T is drawn from the reel R. In FIG. 3 the tape is shown partly through the drawing out process.

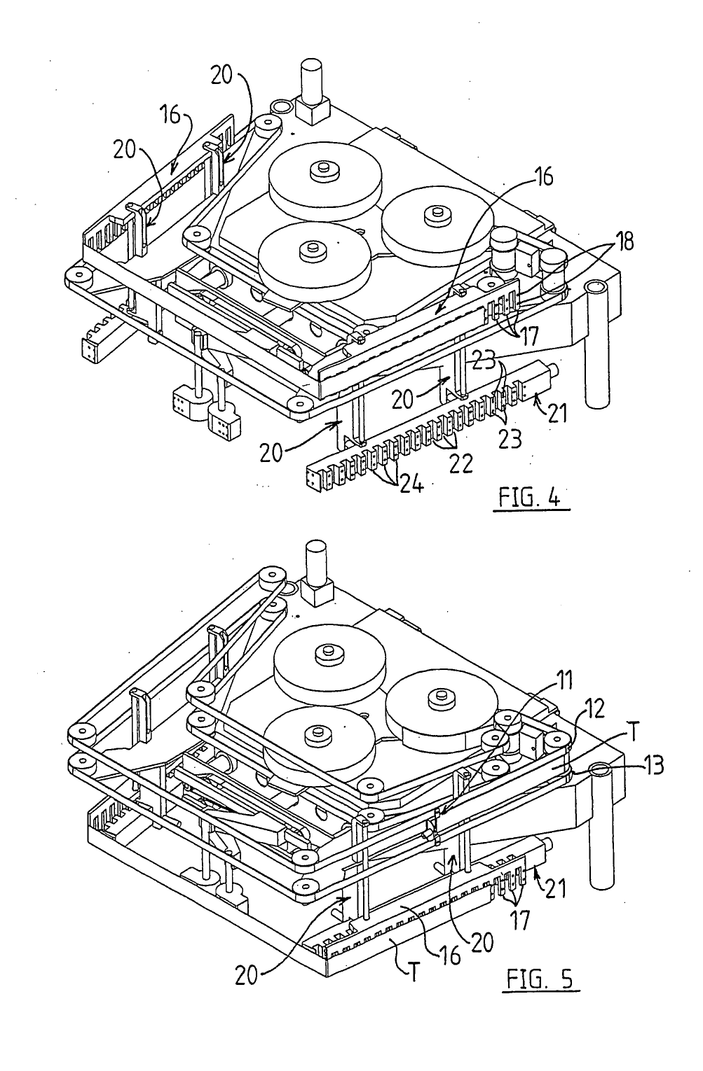

As shown in FIG. 4 the tape T is drawn across the face of two tape holding grids 16, one positioned on either side of the assembly. Each tape holding grid 16 consists of a series of fingers 17 which are hollow and are coupled to a vacuum source via a manifold or the like. Each finger 17 has a plurality of openings 18. The fingers 17 are spaced apart as can be seen in, e.g. FIGS. 2 and 4.

Thus, with sub-atmospheric pressure applied to each of the tape holding grids 16, the tape T can be held in position as shown in FIG. 4. The tape T as shown in FIG. 4 is a single length having been cut by a cutter assembly 14 (hereinafter described) to the required length. The tape holding grids 16 are located behind the tape feed belts system (12, 13) so as to be clear of the belt system and therefore moveable as hereinafter described.

The tape holding grid 15 is supported on a pair of columns or the like 20 and the tape holding grid 16 is therefore, moveable between an upper position (as shown in FIG. 4) and a lower position as shown in FIG. 5. This movement of the tape holding grids 16 can be facilitated by any suitable mechanism such as one or a pair of pneumatic linear actuators.

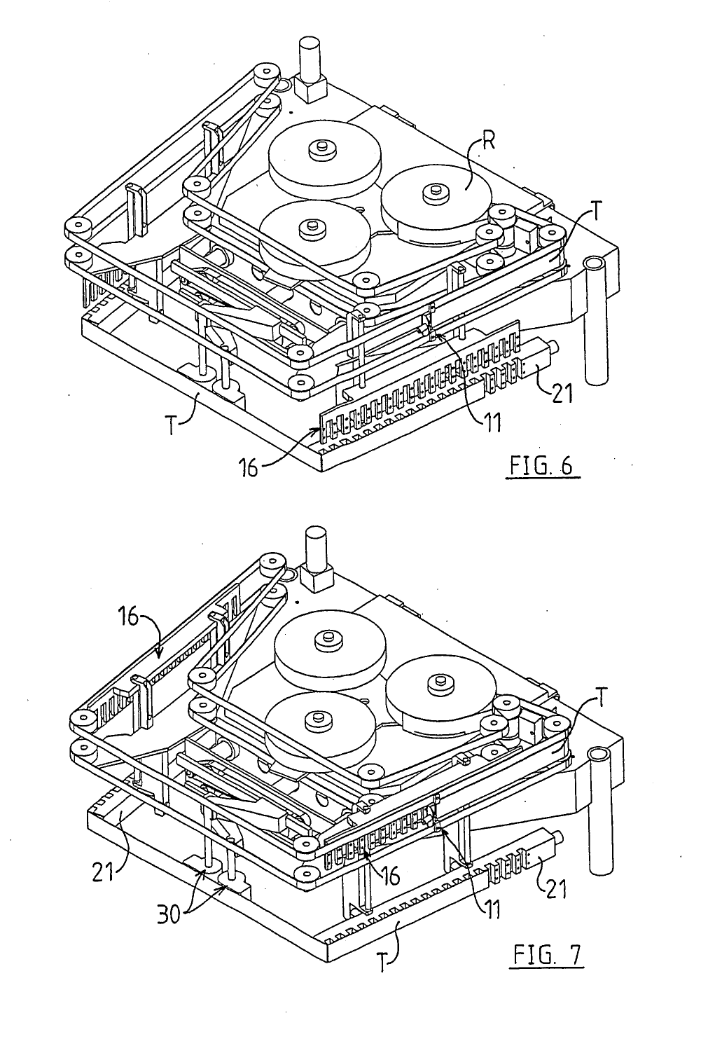

As can be seen in FIG. 5 the tape holding grid 16 when in the lower position is located adjacent a tape application arm 21. Each tape application arm 21 is machined from solid material in much the same fashion as the tape holding grid 16 but with slotted grooves or recesses 22 which correspond in position and with slightly greater physical dimensions than the fingers 17. As can be seen in FIG. 4 each resultant projection 24 is formed with a plurality of openings 23 so that sub-atmospheric pressure applied to the tape application arm 21 enables the cut tape T to be held by the tape application arm 21 (as shown in FIG. 6) when transferred from grid 16.

When the tape holding grid 16 has reached the position as shown in FIG. 5, the fingers 17 are located opposite the grooves or recesses 22 (FIG. 4).

The tape application arms 21 are mounted to be moveable transverse to their length so that the projections 24 engage in the slots between the fingers 17. Accordingly, the tape holding grid 16 and tape application arm 17 interlock though when the application arms 21 move outward the surfaces of the projections 24 become slightly proud of the outward facing surface of the tape holding grid 16.

By vacuum being applied to the application arms 21 and vacuum removed from the tape holding grids 16 the tape is transferred to the application arms 21. As a consequence the tape holding grid 15 can then be raised back to the elevated position to be located behind the next length of tape T drawn from the reel R. Consequently, while the tape T supported by the application arms 21 is applied to a carton the next length of tape T can be drawn out, cut and applied to the tape holding grids 16 in readiness for the next carton to be taped.

It will be appreciated that the bar code reading of the carton will take place in respect of the carton next after the one being taped by the machine. This enables the tape T to be cut to the correct length for the next carton.

In the preferred form of the invention the tape application arms 21 have heating elements buried therein so that the arms can be heated. The heat in the arms 21 is, therefore, transferred into the substrate surface of the tape T. This preferred arrangement enables the cure time of the adhesive of the tape to be reduced because of the preheating of the adhesive, the tape substrate and the area where the tape is to be applied.

FIG. 7 of the drawings shows the tape holding grids 15 raised to the elevated position and the new length of tape T being drawn from the reel R. The length of tape T held by the application arms 21 is ready for application to a carton by way of applicating heads 30.

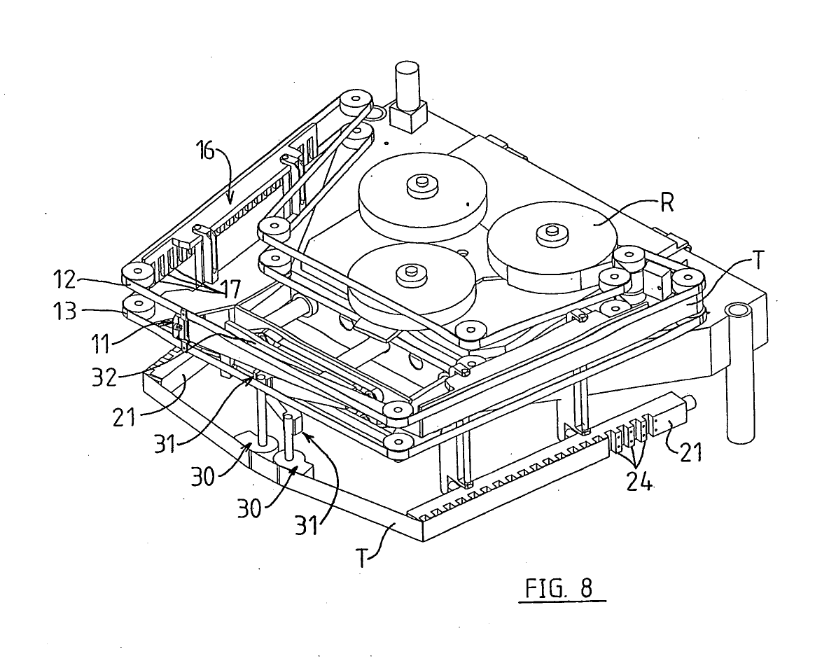

As can be seen in FIG. 8, the applicating heads 30 (of which a preferred form will be described in more detail hereinafter) are each mounted by arms 31 so that, as shown in FIG. 8 the heads 30 can initially be moved toward the carton to create a portion T of tape which will be initially applied to the carton.

According to the arrangement shown in FIG. 8 each arm 31 is slidingly mounted on a transverse track 32. By a suitable drive mechanism the arms 31 can move in opposite directions so that the heads 30 move away from each other and toward the most adjacent application arm 21. Consequently, each head 30 moves from the centre of the carton towards the end of the front sidewall S. Upon reaching the edge of the front sidewall the head 30 is able to rotate so as to continue to push the tape onto end sidewall of the carton as the carton moves between the opposed heads 30 by a conveyor on which the carton fully or partially resides.

In use of the machine cartons are delivered to the machine by an in-feed conveyor (not shown). A mechanism is provided at the entry of the machine to control the entry of cartons such that only one carton at a time moves into the machine i.e. there is a space between the incoming carton and the next carton.

At the in-feed part of the machine a data reader is positioned so as to read the bar code as mentioned previously.

The carton C, which has entered the machine, is prevented from reverse movement by a gate, stop mechanism or the like (not shown). Not only does this mechanism serve as backstop to the carton when it is being taped across the front but also it presents a barrier to the next carton moving into the machine.

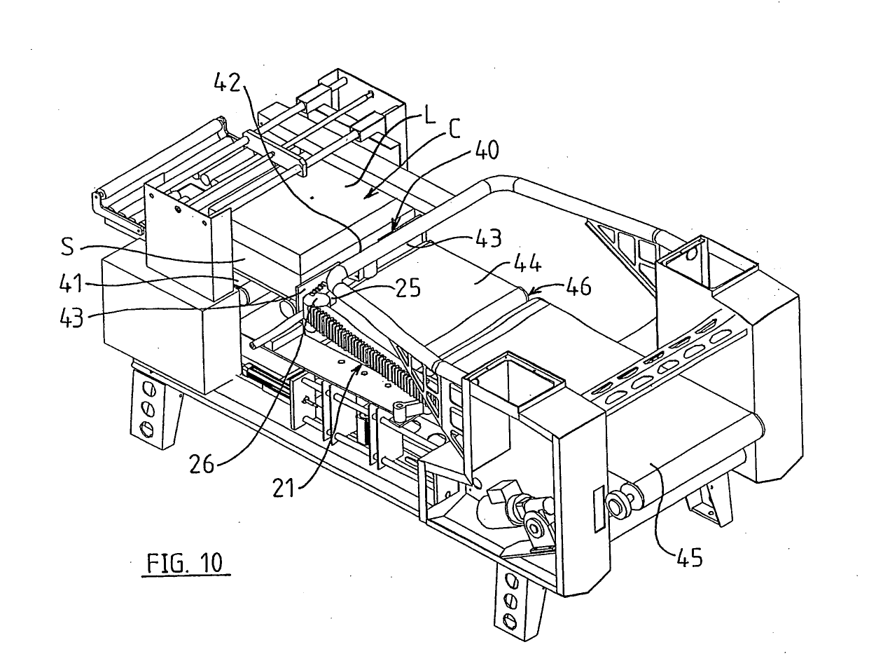

A split flat plate gate 40 (see FIG. 10) elevates from below the transport belt 41 to project above the surface of the transport belt. This holds the front of the carton C square. The gap 42 between the two plates 43 of the gate 40 provides a clearance for the taping heads 30 so that they can make initial contact with the front sidewall of the carton C.

The machine plc control lowers the split flat plate gate 40 to below the surface of the belt 41 and as this occurs the arms 31 move the tape heads 30 in opposite directions across the carton C. The transport belt 41 moves the carton C forward as the heads 30 move around the corner of the box and onto the end sidewalls S and apply the tape to the ends of the carton.

In a preferred form of the invention the carton has pressure applied to the top, bottom ends by way of compression/container rollers or belts so as to ensure that the carton conforms to a “brick” shape.

In a preferred form of the invention each application arm 21 has, at the leading end relative to the incoming carton, a moveable portion 25 which is able to hinge about an axis of a pivot joint 26. Accordingly, as the carton advances and moves between the application arms 21 this moveable portion 25 hinges so that it assumes a position more or less parallel to (or alongside) tie end sidewall of the carton thereby ensuring that the tape as it is drawn off the application arms during movement of the carton relative to the application arms 21 is correctly presented to the end of the carton.

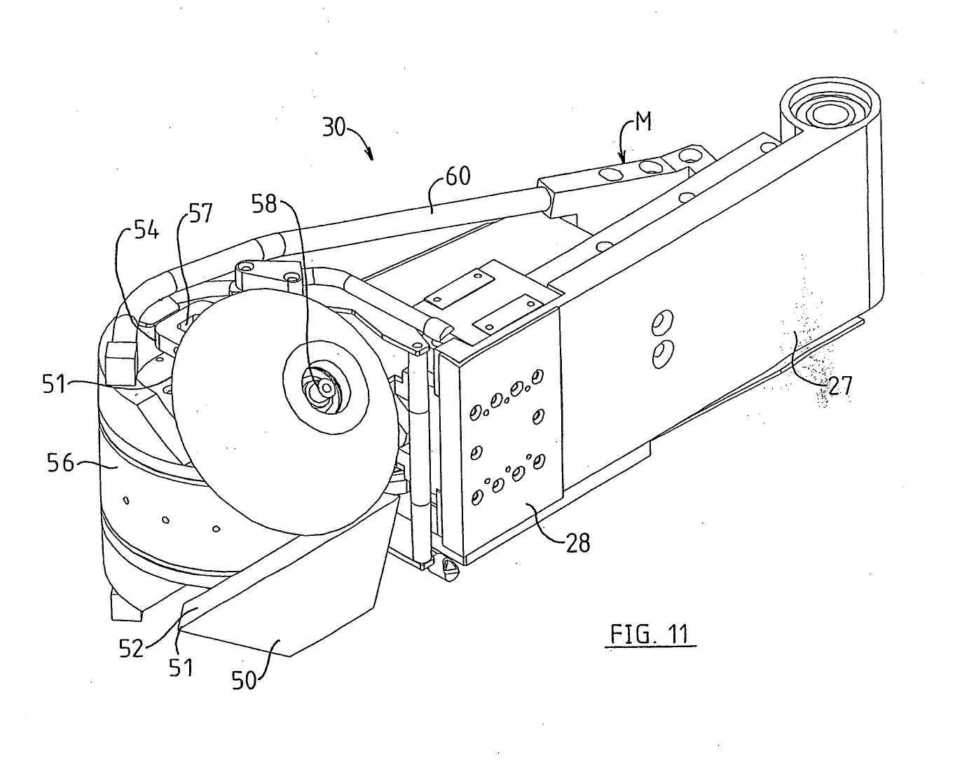

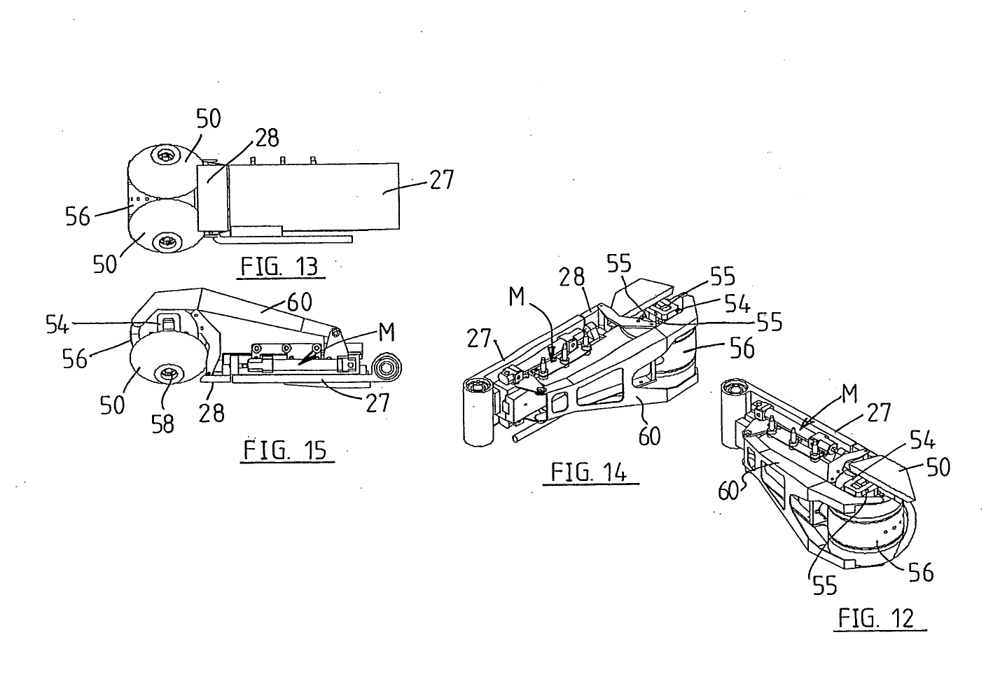

In this form of the invention the applicating head 30 is fastened or mounted to the distal end of the moveable portion 25. Also according to this form of the invention the head 30 is of the type hereinafter described with reference to FIGS. 11-16 of the drawings.

Once the carton has had the tape T applied to the end sidewalls, the applicating heads 30 move across the back sidewall of the carton to complete application of the pre-cut length of the tape. Thus the horizontally taped carton can then be moved out of the machine by output conveyor 45.

Between a conveyor 44, which moves the carton during the tape application process, and the output conveyor 45 there is a gap 46 through which a second plate gate (not shown) can project. This second plate gate engages with the front or leading sidewall of the carton to support the carton against movement while the tape is being applied to the back or trailing sidewall of the carton. Once the tape has been applied to the back sidewall the second plate gate descends thereby clearing the way for the carton to move via output conveyor 45 from the machine.

In FIGS. 2 to 8 the applicating heads 30 are shown in a form where the head is essentially shaped like a first and is able to change its position relative to the carton as the heads move around the front, end and back sidewalls of the carton. However, in the preferred form of the invention the applicating head 30 is of the type shown in FIGS. 11-16 to which reference will now be made.

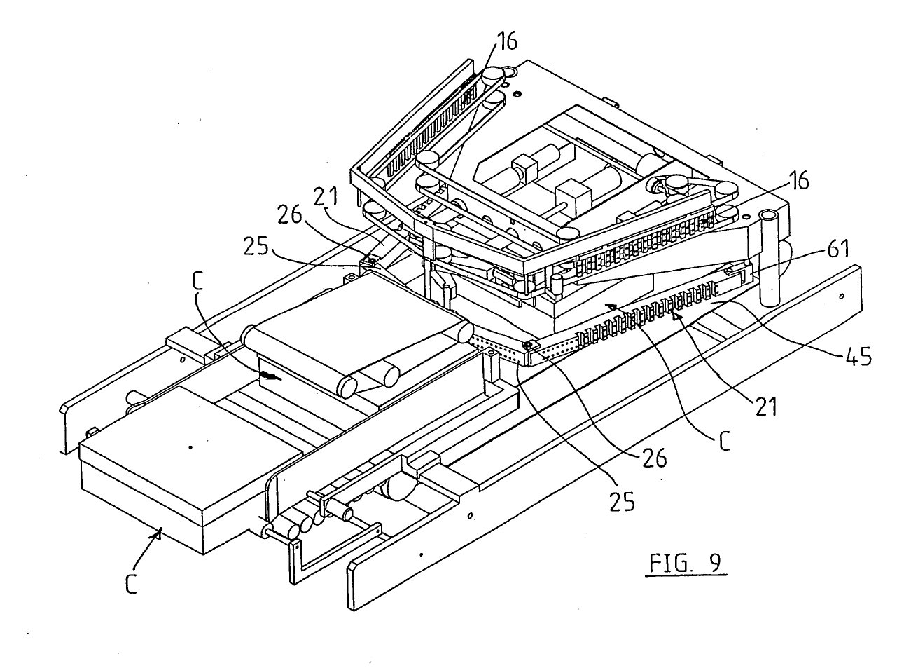

Each head 30 is mounted to the application arm 21 via a body or mounting 27 which is attached to or can form the or part of movable portion 25 (FIG. 9).

Each mounting 27 can include a vacuum/heating pad 28 which is located on the tape feed side of the head. This pad 52 applies tension to the “tail” end of the tape when the tail end of the tape has been removed from the moveable portion 25 or the application arm 21. The heated surface also transmits heat (as is the case with the applicating arm) into the adhesive and substrate to both soften the substrate and precondition the curing time of the adhesive.

Mounted by the frame or body of the head 30 is a pair of freely rotating rotary cones 50 which act as rollers. The rotary cones 50 are disposed as shown in FIGS. 11-15 so that the peripheral larger diameter edges 51 are adjacent one another. The fact that there will be speed differentials between the minor and major circumferences of the rotary cones 50 provides a two-fold effect. On the in-feed side the substrate (tape) being applied to the carton will be converged and the opposing arc will be diverging i.e. “smoothing outward”. The contact circumference (larger) has an ascending, descending horizon but applies point pressure over the greater area.

The lips 52 for cones 50 allow for the tape T to be applied and “smoothed” onto three surfaces of the carton simultaneously (see for example FIG. 16). This is achieved by the cones 50 being able to “offset” to allow for corner taping underneath a surface e.g. into the gutter G. The offset is automatically adjusted depending on the amount of uneven surface with which the cones made contact.

For example, chilled cartons generally have the end flaps of the lid doubled folded to form a 9 mm air gap for air circulation between stacked product, whereas frozen product normally has only 1.5 mm flap thickness. Accordingly, the inverted cones will have a greater offset depending on the more depth which the applicating head needs to content with.

This offset is achieved by the following construction. Each cone 50 is rotatably mounted to a mounting plate 54 which at one end has an angled portion (shown at 54a in FIG. 16) with which the axle or shaft 58 which mounts and establishes the axis of rotation of the rotary cone 50 is attached.

A pair of parallel connecting links 55 extend through an angular passage 59 in a rotary mounting 56. Each link 55 is mounted within the angular passage 59 to be moveable about a pivot axis of pivot 55a. The ends of each link 55 are pivotally coupled by pivots 55b in a shaped slot 57 in the mounting plate 54. As a result of this mounting arrangement the rotary cones 50 can move so as to achieve the offset and the amount offset (shown e.g. in FIG. 16) and can do so continuously as the head moves about the carton so as to accommodate variations in the wall surface and overlap of the lid/flap.

The angular passage 59 is formed in the rotary mounting 56 which is rotatably coupled to head mounting 27 (see FIG. 16). Therefore, under the action of the motor M and associated drive mechanism (which includes link arm 60 between motor M and rotary mounting 56) the angular position of the assembly of rotary cones 50 relative to the head mounting 27 can be incremented in 90° steps through 180°. The motor M is preferably a stepping motor. Positioning is by proximity sensors.

The application arm 21 is mounted at one end by a mounting bracket 61. The moveable portion 25 is supported at or adjacent the applicating head 30 by arm 31 as previously described. As a consequence of these mounting being coupled to a suitable driving or moving arrangement the application arm 21 moveable portion 25 and head 30 can be positioned height-wise so as to align the centre line of the tape T with the gutter G of the carton C. Thus with the tape located in the correct position, it can be applied to contact (according to one preferred form of the invention) 35 mm of the flap F/lid L and 35 mm of the sidewall S and over the depth of 1.5 mm gutter G. This is a typical arrangement with most non-chilled cartons. In such an arrangement the tape is normally 72 mm wide.

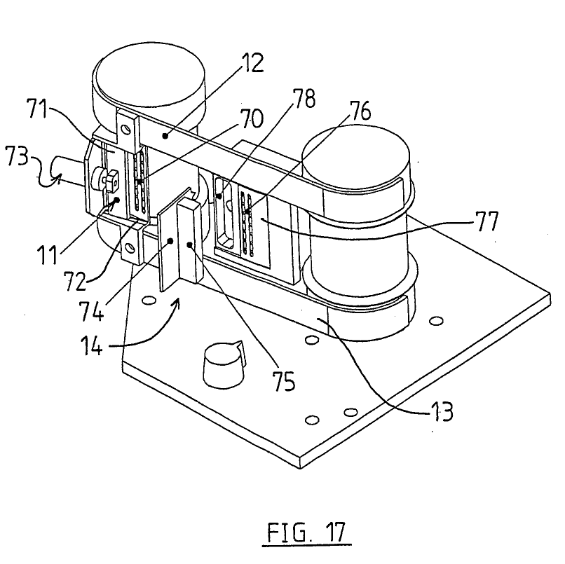

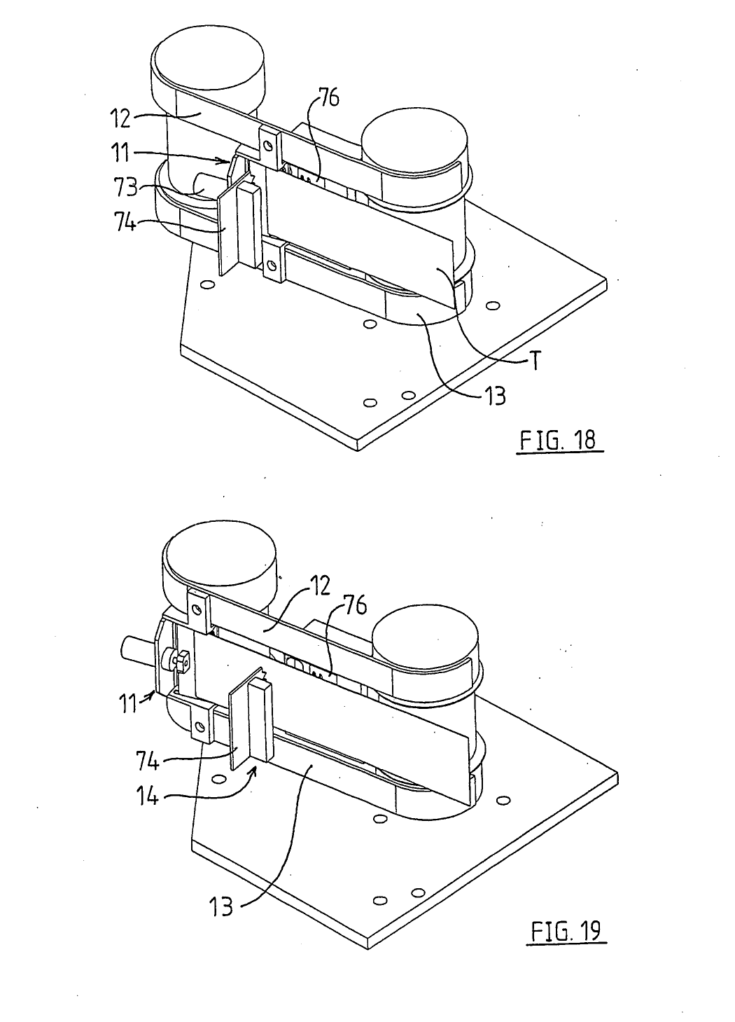

Referring to now to FIGS. 17-19 there is shown a typical gripper and cutter arrangement.

At initialisation of the apparatus the gripper 11 attaches itself to the fag end of the tape T. The gripper 11 is mounted on the twin toothed driven belt arrangement formed by belts 12 and 13. The gripper 11 includes a suction pad 70 and a gripper plate 71. The gripper plate 71 is slidingly moveable in an inclined track 72 and is controlled by a small linear actuator 73.

Accordingly, the fag end of the tape T can be brought into proximity of the suction pad 70 and sucked thereon. The linear actuator 73 is then actuated to slide the gripper plate 71 toward and inwardly (due to the inclined track 72) to mechanically grip the fag end of the tape T between the suction pad 70 and the gripper plate 71.

The cutter arrangement consists of a cutter 74 mounted by a holder 75. The cutter 74 is a serrated blade and is located to one side of the belt system 12 and 13. To the other side of the belt system there is a suction pad 76 which is formed part of a slider 77 which by suitable control means (not shown) can be slid over a chamber 78 which is connected to sub-atmospheric pressure.

Accordingly when the gripper has drawn from the reel R the required length of tape T the slider 77 is moved over the suction chamber 78 so as to apply a suction to the tape whereupon the tape can be cut by the blades 74. The suction created via the suction page 76 (which is positioned over suction chamber 78) holds what becomes the fag end of the tape T while the gripper 11 then moves to a position which corresponds with the required position of the tape T on the tape holding grids 16. It will be appreciated by those skilled in the art that the suction on tape via tape holding grids 16 is sufficient to maintain the tape on the holding grids but not sufficient to prevent the tape T sliding over the tape holding grids 16 as the gripper 11 moves to its final position.

Once the tape T has been transferred to the tape application arms 21 the gripper 11 can return to its “home” position and pick up the fag end of the tape T whereupon suction to the fag end via suction pad 76 is removed to thereby enable the gripper 11 to once again move and draw tape T from the reel R.

In a preferred form of the machine a knife blower is provided in order to blow hot air at high velocity onto the surface of the carton. The knife blower includes a “knife” shape nozzle. The purpose of the knife blower is to clear the board surface of any residual moisture and serves to heat the fibres of the board of the carton prior to the adhesive of the tape making contact with the board. This also speeds up the fusion and cure of adhesive to fibreboard.

It will be appreciated by those skilled in the art that the invention is open to modification. For example, the carton could be positioned on a rotary platen and, therefore, be moveable relative to fixed applicator head(s) and application arms. In fact, it will be apparent to the skilled person that a variety of means can be used to achieve relative movement between the carton, applicator head(s) and application arms to achieve horizontal “wrapping” of the tape around the periphery of the box and pressing of the tape onto the carton.

The invention is particularly useful when applying tape to a carton when a “gutter” is present. However, it will be appreciated that the invention is also applicable to butt jointing of surfaces.

In the preferred form of the invention the tape is first loaded onto the holding grids and then transferred to the application arms. This allows a new length of tape to be dispensed while the previously cut length is applied. However, it will be appreciated that in a less favoured embodiment the holding grids could be arranged (together with the tape dispensing system) so that the tape could be moved off the holding grids and directly onto the carton by the application head(s) and the relative movement of carton, head(s) and holding grids.

The apparatus and method according to the present invention enables adhesive tape to be applied to a carton in such a manner that a hermetic seal is achieved, which is highly advantageous for the packaging of meat, fish and the like as this adds to the freezing process where the meat, fish or the like is blast frozen following packaging.

The adhesive tape is applied in such a manner that it not only provides a strong coupling of the flap or lid to the body of the carton but also aids in the strength and integrity of the carton. The use of the applicating heads in the manner in which the tape is correctly position and held taut (flat) at the point of application results in the tape being applied to uneven surfaces in such a manner that the tape follows the contours between the surfaces.

1-33. (canceled)

34. Apparatus for applying adhesive tape to an article having first and second surfaces to be securely joined together by the adhesive tape the apparatus including a tape dispenser, a tape holder for holding a length of tape from the tape dispenser and position the tape adjacent the first and second surfaces, pressure applicator operable to press an area of the tape onto said first and second surfaces and a mover to cause relative movement between the pressure applicator and first and second surfaces to cause the tape to become adhered to and join the first and second surfaces.

35. Apparatus as claimed in claim 34 wherein the tape holder is moveable relative to a second tape holder, there being a transfer mechanism operable to transfer the length of tape to the second tape holder.

36. Apparatus as claimed in claim 35 wherein the second tape holder is moveable to position the tape relative to the first and second surfaces.

37. Apparatus as claimed in claim 34 wherein the pressure applicator includes at least one applicator head which is contactable with the non-adhesive side of the tape, there being a mechanism operable to cause relative movement between the first and second surfaces and the applicator head to cause said area of the tape to contact the first and second surfaces.

38. Apparatus as claimed in claim 37 wherein the applicator head includes a pair of rotatable elements mounted for relative movement therebetween whereby one rotatable element can be offset to the other rotatable element.

39. Apparatus as claimed in claim 38 wherein each rotatable element is at least in part of conical shape, the conical surface forming a contact surface for pressing the tape onto the first or second surface.

40. Apparatus as claimed in claim 39 wherein the apex of the conical shape or the end, which is of smaller diameter is located more distant from the join of the first and second surfaces than the end of the largest diameter.

41. Apparatus as claimed in claim 40 wherein at least one of the conical rotatable elements includes a second contact surface, which inclines away from the largest diameter of the conical shape.

42. Apparatus as claimed in claim 37 wherein the applicator head(s) is/are moveable relative to the first and second surfaces.

43. Apparatus as claimed in claim 42 wherein the first and second surfaces are also moveable in relation to the changing position of the applicator head(s).

44. Apparatus as claimed in claim 37 wherein the applicator head(s) is/are held in a substantially fixed position and the first and second surfaces are moveable by moving means.

45. Apparatus as claimed in claim 34 wherein the apparatus includes control means, which responsive to sensor means determining a type of article incorporating the first and second surfaces controls the dispenser to cut the tape to a required length.

46. Apparatus as claimed in claim 34 wherein the dispenser includes a reel of tape, a movable gripper to draw tape from the reel and a cutting device to cut the tape at the required length.

47. Apparatus as claimed in claim 34 wherein the apparatus is arranged to perform horizontal application of tape to a carton.

48. Apparatus as claimed in claim 47 wherein the tape holder holds tape relative to the carton across a front face of the carton and the mover applies relative movement between the carton and tape holder whereby the tape once applied across the front fence is pressed by the pressure applicator along the sides of the carton.

49. In an apparatus for applying adhesive tape to an article an applicator head for application of adhesive tape to first and second surfaces of the article to join the surfaces together, the applicator head being contactable with the non-adhesive side of the tape via elements in the form of a pair of rotatable elements mounted for relative movement therebetween whereby one rotatable element can be offset to the other rotatable element.

50. An applicator head as claimed in claim 49 wherein each rotatable element is at least in part of conical shape, the conical surface forming a contact surface for pressing the tape onto the first or second surface.

51. An applicator head as claimed in claim 50 wherein the apex of the conical shape or the end which is of smaller diameter is located more distant from the join of the first and second surfaces than the end of the largest diameter.

52. An applicator head as claimed in claim 50 wherein at least one of the conical rotatable elements includes a second contact surface which inclines away from the largest diameter of the conical shape.

53. A method of applying a length of adhesive tape to an article to secure a first component of the article having a face surface and an edge surface to a face surface of a second component of the article, the method comprising the steps of holding the length of tape in a position relative to face and edge surfaces, bringing a pressure applicator into contact with an area of the tape to cause the tape in the vicinity of the contact area to contact said surfaces and then cause relative movement between said surfaces and the pressure applicator to occur to thereby cause the length of tape to become adhered along its length to the surfaces and follow the contour of the surfaces.

54. The method of claim 53 further including the step of drawing tape from storage means onto a tape holder and cutting the tape to length.

55. The method of claim 54 wherein the tape holder is moveable to move the length of tape to said position relative to the face and edge surfaces.

56. The method of claim 55 wherein the length of tape is transferred from said tape holder to second tape holder prior to the pressure applicator causing the area of tape to contact the surfaces.

57. The method of claim 56 wherein the tape holder is a reel.

58. The method of claim 53 wherein the pressure applicator is moved and the surfaces remain stationary.

59. The method of claim 53 wherein the surfaces are moved and the pressure applicator remains stationary.

60. The method of claim 53 wherein both the pressure applicator and the surfaces are moved.

61. The method of claim 53 wherein the first component is a closure of a carton and the second component is a case of the carton, the tape being applied horizontally around the carton.

62. The method of claim 61 wherein the tape is applied for the full peripheral extent of the carton.

63. The method of claim 53 wherein the pressure applicator has first and second moveable pressure devices one being cause to press part of the tape onto the face surface of the closure and the other being caused to press part of the tape onto the edge surface of the closure and the face surface of the case.
